(19) United States
(12) Patent Application Publication
(10) Pub. No.: US 2002/0075138 A1
(43) Pub. Date: Jun. 20, 2002

(54) Portable object detection system

(76) Inventors: H. Barteld Van Rees, Needham, MA (US); Delbert Lippert, Cobden (CA); Walter Gordon Woodington, Lincoln, MA (US); Michael Joseph Delcheccolo, Westford, MA (US); Mark E. Russell, Westford, MA (US); Scott H. Schneider, Andover, MA (US)

Correspondence Address: DALY, CROWLEY & MOFFORD, LLP, SUITE 101, 275 TURNPIKE STREET, CANTON, MA, 02021-2310, US

(21) Appl. No.: 09/931,276

(22) Filed: Aug. 16, 2001

Related U.S. Application Data
(60) Provisional application No. 60/226,160, filed on Aug. 16, 2000.

(51) Int. Cl. B60Q 1/00

(52) U.S. Cl. 340/436; 340/903

(57) ABSTRACT

A portable radar system includes a radar sensor coupled to a radar display. The radar sensor and radar display can be portably mounted to a vehicle. The radar system provides a portably mounted radar transceiver with an integral or separately portably mounted visual display and optionally an integral or separately portably mounted audible alert device. The portable radar system can be mounted to the interior of side windows of the vehicle or to any other interior or exterior surface of the vehicle through which radar energy can effectively propagate.

### RELATED APPLICATIONS

This application claims the benefit of U.S. Provisional Application No. 60/226,160, filed on Aug. 16, 2000 which application is hereby incorporated herein by reference in its entirety.

### GOVERNMENT RIGHTS

Not Applicable.

### FIELD OF THE INVENTION

This invention relates generally to an automobile radar system and more particularly to an automobile radar system that can be portably mounted to an automobile for detecting objects in the blind spot of the automobile.

### BACKGROUND OF THE INVENTION

A continuing problem in the operation of automobiles is the difficulty in seeing objects and other vehicles that are to the side of a given automobile, i.e. in the side blind spots of the automobile. Blind spots result in numerous accidents as the operator of an automobile changes lanes.

Common solutions to this problem include rear view mirrors with various placements and with various sizes. In particular, a convex mirror can view a larger area than a flat mirror, but an object viewed in such a mirror appears farther away than the actual distance to the object. The view through a mirror is also poor during conditions of rain, snow, or darkness.

There is a need for a simple solution to the problem of detecting hazardous obstacles in the blind spots of a vehicle. In particular, a detection that can be made during conditions of rain, snow, or darkness is desirable.

As is known in the art, radar systems have been developed for various applications in association with automobiles and other vehicles. For example, radar systems have been proposed and built that detect the presence of objects in proximity to an automobile on which the radar is mounted.

A radar system is typically optimized in shape and materials for the transmission and reception of radar energy and is not well suited to match the appearance of the body of the automobile. Thus, when mounted on the outer surface of the body of a vehicle, such as an automobile for example, a radar system is generally not aesthetically appealing.

Furthermore, automobile manufacturers, with a desire to optimize fuel efficiency, provide automobile shapes that are generally aerodynamically efficient. The radar system is not typically aerodynamically efficient when mounted to the body of an automobile since the shape of the radar system is typically optimized for effective transmission and reception of radar energy and not generally optimized for low drag.

Radar systems used for the detection of objects in proximity to the vehicle have been permanently mounted. Radar system designs have required permanent mounting due to the large size of such radar systems. Such systems that are permanently mounted must be integrated into the design of the vehicle and are thus not available for use on vehicles that have not been so integrated. Thus, the operators of those vehicles do not have the benefit of radar systems that detect objects in proximity to the vehicle.

It would, therefore, be desirable to provide a system for the detection of objects in proximity to a vehicle that need not be integrated into the design of the automobile and which thus may be mounted to the automobile after the automobile has been manufactured.

### SUMMARY OF THE INVENTION

A portable object detection system provides a radar transceiver portably attached to the vehicle, optionally a radar display portably attached to the vehicle, and optionally an audible alert device portably attached to the vehicle. The portable object system can be mounted internally to the vehicle, or externally to the vehicle, or partially internally and partially externally. The portable radar system is adaptable to an automobile or to any vehicle upon which a radar system is mounted.

With this particular arrangement, a radar system is provided that is adaptable to any vehicle during or after manufacture of the vehicle. By providing the portable radar system in a compact package, the radar system can be unobtrusively disposed in the vehicle and thus neither detract from the aesthetic appearance of the vehicle nor from the drag characteristics of the vehicle.

### BRIEF DESCRIPTION OF THE DRAWINGS

The foregoing features of the invention, as well as the invention itself may be more fully understood from the following detailed description of the drawings, in which:

FIG. 1 is a top view of a portion of an automobile having a part of radar system portably mounted on a window thereof;

FIG. 1A is a side view of the portion of the automobile of FIG. 1;

FIG. 2 is a top view of a tractor-trailer combination having two radar systems portably disposed on an external portion of the trailer portion of the combination;

FIG. 3 is an isometric view of a portable radar system; and

FIG. 4 is a top view of a detection zone which can be provided by the radar system.

### DETAILED DESCRIPTION

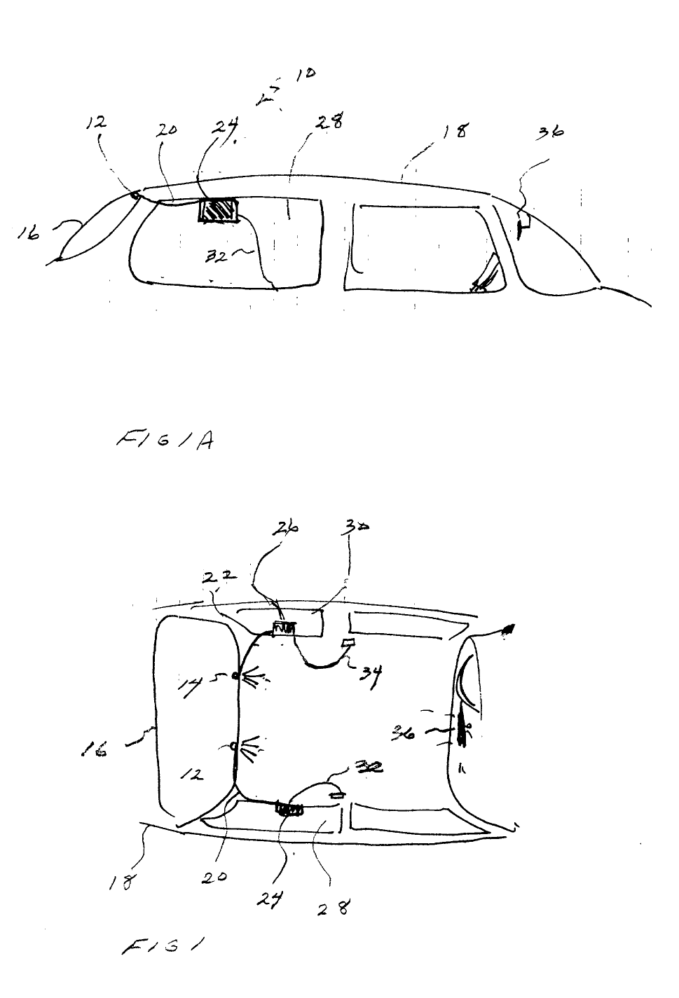

Referring to FIGS. 1 and 1 A, in which like elements are provided having like reference designations, a vehicle 18, here shown as an automobile, has a pair of radar displays 12, 14, for example lights or LEDs, mounted to a surface of a rear window 16 of the automobile 18. In this particular embodiment, the displays 12 are disposed on an inner surface of the rear window. The radar displays are coupled to radar sensors 24, 26. In one particular embodiment, the radar displays 12, 14 are coupled sensors 26, 28 via respective ones of wires 20, 22. In other embodiments, however, a wireless connection can be used between the displays 12, 14 and sensors 26, 28.

The radar sensors 24, 26 may be of a type, for example, described in U.S. Patent Application entitled Radar Transmitter Circuitry and Techniques, filed on Aug. 16, 2001, and assigned Application No. 09/______, and U.S. Patent Application entitled Highly Integrated Single Substrate MMW Multi-Beam Sensor, filed on Aug. 16, 2001, and assigned Application No. 09/______, each of which are assigned to the assignee of the present invention and incorporated herein by reference. It should be appreciated of course that other radar sensors can be used in accordance with the present invention. The radar sensors employed in this invention are radar transceivers that both transmit and receive radar energy.

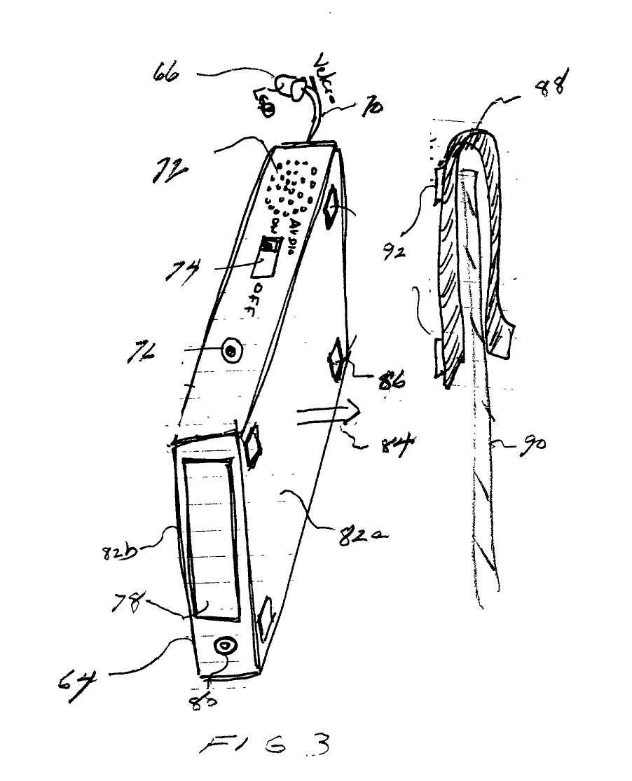

The radar sensors 24, 26 are each portably mounted to the interior surface of the side windows 28, 30. The radar sensors 28, 30 can be mounted to window brackets or can be mounted directly on the windows 28, 30. An illustrative window bracket is shown in FIG. 3. Wires 32, 34 couple respective ones of the radar sensors 24, 26 to a power source (not shown) such as a car battery or other power source provided as part of the vehicle 18. It should be appreciated, however, that alternative power sources, such as rechargeable or non-rechargeable batteries, can also be used to provide power to the sensor.

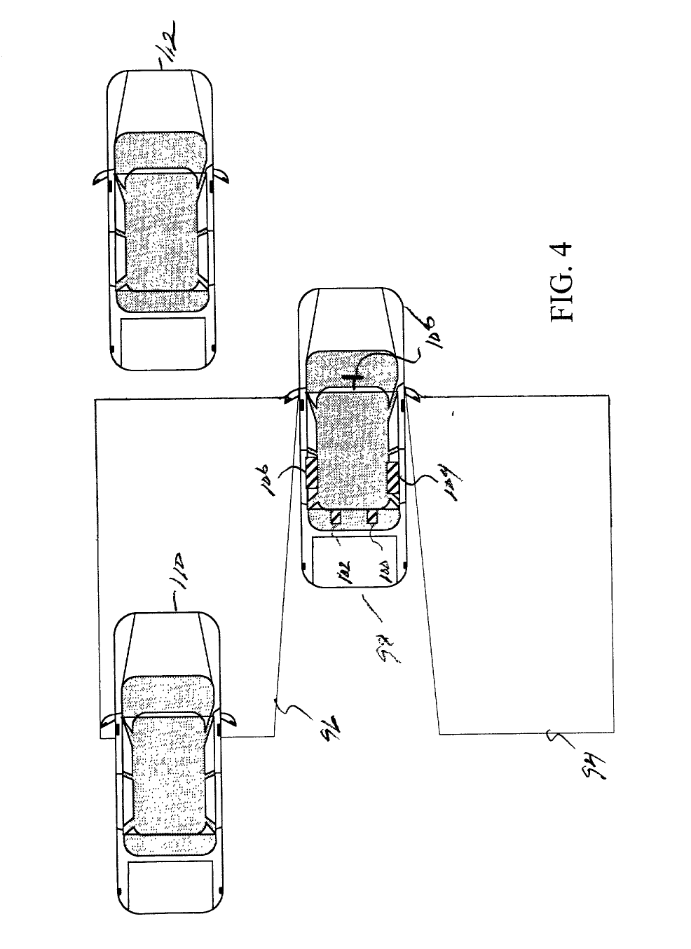

In operation, if one of sensors 24, 26 detects an object within its detection zone, the sensor causes the corresponding display 12, 14 to provide an indication that a sensor has detected an object in its detection zone. An operator of the vehicle 18 receives the indication, via the conventional rear view mirror 36 in which the operator can see radar displays 12, 14. In this manner, the detection system alerts the operator of the vehicle to the presence of the object within the detection zone associated with each radar sensor 24, 26. The detection zones will be described further in conjunction with FIG. 4 below.

Alternatively, or in addition to visual indications provided by the displays 12, 14, the radar system 10 can provide an audible indication of a detected object with an audible alert device. Though not shown in the figure, it will be recognized by one of ordinary skill in the art that the audible indication can be provided by an audible alert device within the radar displays 12, 14, or the radar sensors 24, 26 or with a separate audible alert device. In some embodiments, it may be desirable, or even necessary to utilize only an audible alert device and in this case, the radar displays 12, 14 are optional.

Although two radar systems 24, 26 and two displays 12, 14 are here shown and described, it should be appreciated that fewer or more than two radar systems and displays can also be used. The particular number of radar systems and displays to use in any particular application is selected in accordance with a variety of factors including but not limited to the size and shape of the vehicle, the number of blind spots on the vehicle, and the location of vehicle blind spots. Also, it will be recognized that two or more radar systems 24, 26 may be mutually coupled to one radar display. Likewise one, two, or more displays can be coupled to a single radar sensor. Furthermore, while the illustrative embodiment shows the radar system 10 disposed internal to the automobile 18, on the interior surface or the side windows 28, 30, the radar system 10 could also be disposed external to the automobile 18, for example on the exterior surface of the side windows 28, 30.

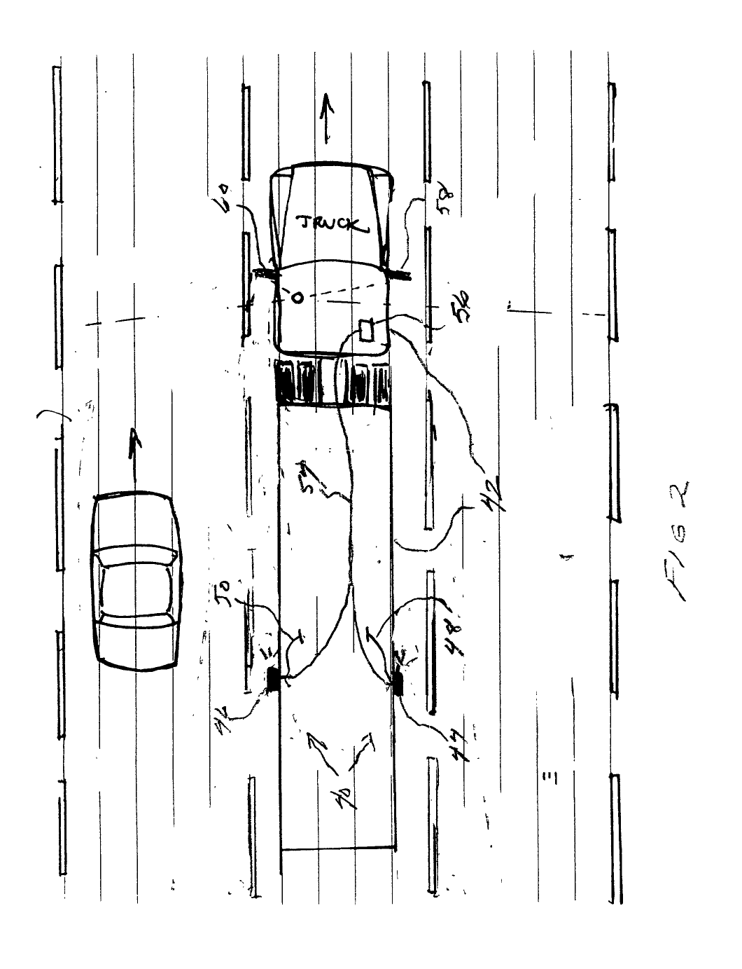

Referring now to FIG. 2, a tractor-trailer combination 42 (sometimes referred to herein as a truck 42) has a portable side object detection (SOD) system 40 disposed thereon. Radar sensors 44, 46 are mounted on opposing sides of the trailer portion of the combination 42. In this illustrative embodiment, radar displays are integral to the radar sensors. The radar sensors 44, 46 are coupled with wires 48, 50 to the power system of the combination 42 to provide power to the radar sensors 44, 46. Optionally, the radar sensors 44, 46 can be coupled with a wire 54 to an audible alert device 56 located in the cab portion of the tractor portion of the combination 42

An operator of the truck 42 receives an indication, via the conventional side rear view mirrors 58, 60 in which the operator can see radar displays integral to the radar sensors 44, 46, of the presence of an object within a detection zone associated with each radar sensor 44, 46. It will be recognized by one of ordinary skill in the art that separate radar displays, for example radar displays 12, 14 of FIG. 1 can be used with this alternate illustrative embodiment. It will also be recognized that the audible alert device 56 can be provided either in addition to radar displays associated with radar sensors 44, 46, or in place of the radar displays.

Referring now to FIG. 3, a radar sensor 64 includes a housing having disposed therein one or more radiating sensor elements, an audio output port 72 for an audio detection alert, and audio alert on/off switch 74, a display connector 76 for attachment of the radar display cable, such as the cables 20, 22 of FIG. 1, a battery port 78 for attachment of batteries in the alternative power arrangement, and a power connector 80 for attachment of vehicle power, such as the cables 32, 34 of FIG. 1. An electrical connection 70 couples an LED to the housing of the sensor 64.

The radar sensor 64, has a radiating face 82a from which radar energy 84 propagates in order to detect objects. The radiating face 82a can be mounted to the inside surface of an automobile window, either directly, for example with adhesive Velcro strips 86, or with a mechanical mounting arrangement of which the illustrative clip 88 is but one example. The illustrative clip 88 is placed over the top edge of a side window 90 of the automobile and the radar sensor 64 is attached to the clip 88 with Velcro 86, 92. The radar sensor is thus portably mounted to the automobile.

An illustrative radar sensor 64 is provided having a length of 12.7 cm, a width of 7.6 cm and a thickness of 3.8 cm, where the thickness corresponds to the distance between the two surfaces 82a, 82b. It will be recognized by one of ordinary skill in the art that radar systems with other dimensions can be used with this invention. It will be further recognized that other mounting structures and techniques in addition to the clip 88 are possible with this invention, including screws and snap structures.

It will be further recognized by one of ordinary skill in the art that other techniques in addition to the connector 80 can be used to provide power to the radar sensor, for example, internal batteries can provide power for the radar sensor 64. It will be further recognized by one of ordinary skill that the radar sensor 64 can be oriented in any azimuth orientation relative to the automobile. It will be further recognized by one of ordinary skill in the art that the radar sensor 64 can be mounted to any window or to any interior or exterior surface of the vehicle, so long as the radiating face 82a is not placed behind a surface through which radar energy cannot propagate effectively. Furthermore, it should be understood that it is necessary to orient the sensor 64 in a particular direction such that it is possible to obtain a preferred detection zone about the vehicle.

Referring now to FIG. 4, two illustrative side detection zones 94, 96 are shown in association with a vehicle 98 to which two radar displays 100, 102 are affixed. The radar displays are coupled to radar sensors 104, 106 as mentioned above in conjunction with FIG. 1 As mentioned above, an operator of the vehicle 98 receives an indication of the presence of an object within a detection zone 94, 96 associated with each radar sensor 104, 106, respectively, for example via a rear view mirror 108 in which the operator can see radar displays 100, 102.

The radar sensors 104, 106 can detect the presence of a vehicle 110 that enters the detection zone 96, while not detecting the vehicle 112 that is outside of the detection zone 96. The vehicle 110 is in the blind spot of the vehicle 98 and thus represents a potential danger when vehicle 98 changes lanes. An indicator in radar display 102 indicates to the driver of vehicle 98 that vehicle 110 is in the left blind spot of vehicle 98.

All references cited herein are hereby incorporated herein by reference in their entirety.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1) A vehicle radar system comprising:
a radar transceiver portably attached to the vehicle.

2) The vehicle radar system of claim 1 further comprising:
a radar display portably attached to the vehicle.

3) The vehicle radar system of claim 2, wherein the radar display is portably attached to the interior of the vehicle.

4) The vehicle radar system of claim 2, wherein the radar display is portably attached to the exterior of the vehicle.

5) The vehicle radar system of claim 2, wherein the radar transceiver is portably attached to a vehicle window.

6) The vehicle radar system of claim 1, further comprising:
a radar display disposed upon the radar transceiver.

7) The vehicle radar system of claim 1, wherein the radar transceiver is portably attached to the interior of the vehicle

8) The vehicle radar system of claim 1, wherein the radar transceiver is portably attached to the exterior of the vehicle

9) The vehicle radar system of claim 1, wherein the radar transceiver is portably mounted to a vehicle window.
